(19) United States
(12) Patent Application Publication
(10) Pub. No.: US 2003/0174419 A1
(43) Pub. Date: Sep. 18, 2003

(54) Optical assembly and method of making

(76) Inventors: David Kindler, Concord, MA (US); Tom Killoren, Holliston, MA (US); Guy Messier, Norwood, MA (US)

Correspondence Address: DAVID L. FEIGENBAUM, Fish & Richardson P.C., 225 Franklin Street, Boston, MA, 02110-2804, US

(21) Appl. No.: 10/313,214

(22) Filed: Dec. 6, 2002

Related U.S. Application Data
(60) Provisional application No. 60/337,865, filed on Dec. 6, 2001.

(51) Int. Cl. G02B 7/02

(52) U.S. Cl. 359/819

(57) ABSTRACT

An optical assembly method in which one or more stabilizing elements (e.g., a balls) are positioned between the module and the base plate after it has been optimally positioned by active alignment, but before it is permanently attached to the base plate. While the stabilizing elements are absent, there is a space between the module and the base plate to permit active alignment. After the active alignment is complete, the stabilizing elements are positioned to stabilize the position of the module and reduce the impact of external forces associated with permanently attaching the module to the base plate (e.g., adhesive shrinkage).

### CROSS-REFERENCE TO RELATED APPLICATIONS

This applications claims priority under 35 USC §119(e) to U.S. Provisional Application Serial No. 60/337,865 entitled “Means of rigidly attaching components to an optical bench” by David Kindler et al. and filed Dec. 6, 2001, the contents of which are incorporated herein by reference.

### BACKGROUND

Telecommunication networks increasily use optical signals as a means for transmitting information. Optical fibers carry such signals between different nodes in the telecommunications network. Also, multiple optical fibers can be combined in a fiber array to improve signal capacity and/or to provide redundancy. Typically, one or more optical components are positioned at each node to generate, process, alter, detect, and/or monitor the optical signals. To prevent signal losses, it is important to optimize the optical coupling efficiency at each node.

Often such coupling occurs through free space. For example, an optical beam emerges from a first module and is directed through free space to a second module. The modules may carry components for carrying the optical signal (e.g., a fiber, a fiber array, and/or an integrated waveguide) and/or components for manipulating the optical signal (e.g., components for generating, processing, altering, detecting, and/or monitoring the optical signal). The two modules need to be properly aligned with one another to optimize the optical coupling efficiency. To facilitate such alignment, each module is typically mounted and secured onto a common base plate. The base plate provides stability for the resulting optical assembly.

The base plate and modules may also be fabricated with preset features that mate with one another to register and align the optical axes of the modules. For example, protrusions on the bottom faces of the modules can mate with corresponding grooves on the top face of the base plate to lock-in a preset alignment. In some cases, the protrusions may correspond to balls secured to corresponding recesses of the modules. Such mating features may be fabricated by using, for example, established photolithography and crystallographic etching techniques from the semiconductor industry, especially where the base plate and/or the modules are made out of silicon.

The use of such preset mating features to optically align the modules is referred to as “passive alignment.” Advantages of passive alignment include simplicity and stability. The mating features uniquely position the modules relative to one another. The modules are then then permanently secured to the base plate by, e.g., mechanical clamping, glue, and/or solder, to form the completed optical assembly. On the other hand, passive alignment prevents subsequent optimization of the relative positions of the modules, relying instead on the accuracy of the preset features.

“Active alignment” involves adjusting the relative position of the modules on the base plate. A vacuum chuck or mechanical arm may be used to adjust the position of one of the modules and the adjustments themselves may be made in response to some measure of the optical coupling efficiency between the modules. For example, the relative position of the modules can be adjusted in response to the degree of transmission of an optical beam emerging from one module and entering into another module. Such active alignment can optimize the relative position of the modules in situ.

### SUMMARY

The inventors have recognized that an important advantage of passive alignment is that the modules are in intimate mechanical contact with the base plate when glue, solder, and/or mechanical clamping is used to permanently form the optical assembly. As a result, the stability of the aligned modules is retained even as they are subject to external forces caused by the permanent attachment. Such external forces can include, for example, glue shrinkage, solder shrinkage, heat for melting solder, spring loads from mechanical fixturing, and ultraviolet (UV) exposure for UV-curable adhesives.

The inventors have also recognized the advantages associated with active alignment, particularly the ability to optimize the relative positions of the assembly elements in situ. On the other hand, the inventors have recognized that active alignment requires space (e.g., a “gap”) between at least one of the modules and the base plate to allow for relative motion when optimizing the relative position of the modules. This same gap, however, limits the stability of the optimally positioned module when it is subject to the external forces associated with permanently attaching it to the base plate.

The inventors have discovered an optical assembly method in which one or more stabilizing elements (e.g., a balls) are positioned between the module and the base plate after it has been optimally positioned by active alignment, but before it is permanently attached to the base plate. While the stabilizing elements are absent, there is a sufficient gap to permit active alignment. After the active alignment is complete, the stabilizing elements are positioned to stabilize the position of the module and reduce the impact of external forces associated with permanently attaching the module to the base plate.

In one set of embodiments, the stabilizing elements are balls (typically having different sizes) and the optimal position of the module is nominally preset so that the underside of the module is angled relative to the base plate. After the module is actively aligned, the balls are translated along multiple tracks in the base plate until they contact the optimally positioned module. At least three balls are used to define a three-point contact and fix the plane of the module relative to the plane of the base plate. In preferred embodiments, each ball contacts the underside of the module along a planar surface, in which case each ball contacts the module at only a single point, thereby minimizing any disturbance of the optimally positioned module. Glue (e.g., an adhesive epoxy), solder, and/or mechanical fixturing may be then used to permanently attach the module to the base plate. Although such attachment means may tend to pull the module and base plate closer to one another, the impact of such forces are reduced by the presence of the balls and the optimal position is retained.

In another set of embodiments, the module includes one or more holes passing through it. After the module is actively aligned, at least one stabilizing element is introduced into each hole to contact the base plate. For example, each stabilizing element may be a ball that is slightly undersized relative to its corresponding hole. Positioned as such, the stabilizing elements take-up any gap between the module and the base plate. Glue and/or solder can then be applied in the vicinity of the hole to permanently attach together the module, base plate, and stabilizing elements. Because the stabilizing elements cause the glue/solder volume to be small, corresponding shrinkage forces are small and the optimal position is retained.

In either set of embodiments, the module and base plate may further include mating features to guide an initial nominal alignment of the components prior to their active alignment.

We now summarize different aspects and features of the invention.

In general, in one aspect, the invention features a method for securing a first optical module to a base plate supporting one or more additional modules. The method includes: i) positioning the first module relative to the base plate to optically couple the first module with the one or more additional modules; ii) introducing at least three stabilizing elements between the aligned first module and the base plate; iii) positioning each stabilizing element to contact both of the aligned first module and the base plate; and iv) securing the first module to the base plate after the stabilizing elements are in position.

Embodiments of the method may include any of the following features.

The three stabilizing elements may be balls. Furthermore, the balls may have different dimensions.

Each stabilizing element may be positioned to contact at least one of the aligned first module and the base plate at only one point.

The first module may have a planar surface and the stabilizing elements may be positioned to contact the planar surface.

The stabilizing elements may be positioned to contact the aligned first module at a first set of points and the base plate at a second set of points, wherein the first set of points defines a first plane that is angled relative to a second plane defined by the second set of points. Furthermore, the positioning of the stabilizing elements may include translating each stabilizing element between the first and second planes until it contacts both of the aligned first module and the base plate. For example, the translating may include applying a mechanical, gravitational, and/or magnetic force to each stabilizing element. Moreover, one of the first module and the base plate amy include at least one track to guide the translations of the stabilizing elements. For example, the base plate may include the track. Moreover, the at least one track may be multiple tracks. For example, the multiple tracks may be oriented substantially parallel to one another.

The positioning of the first module relative to the base plate may include positioning the first module relative to the base plate based on transmission efficiency of an optical signal between the first module and the one or more additional modules. Furthermore, the positioning of the first module relative to the base plate may also include passively aligning the first module relative to the base plate prior to the positioning of the first module relative to the base plate based on the transmission efficiency of the optical signal. In any case, the positioning of the first module relative to the base plate may include using a vacuum chuck.

The first module may be adhesively secured to the base plate, it may be secured to the base plate by solder, and/or it may be secured to the base plate with a mechanical clamp. For example, it may be secured to the base plate by a mechanical clamp while an adhesive or solder is allowed to harden to permanently secure them together, after which the mechanical clamp may be removed.

Where an adhesive is used, it may be applied to at least one of the first module and the base plate before the stabilizing elements are introduced and allowed to harden after the stabilizing elements are in position. Alternatively, the adhesive may be applied to at least one of the first module and the base plate after the stabilizing elements are introduced and then hardened to adhesively secure the first module to the base plate.

The adhesively securing may further include exposing the adhesive to ultraviolet radiation, exposing it to an anaerobic environment, and/or adjusting temperature to cure the adhesive. Typically, the stabilizing elements have a coefficient of thermal expansion substantially closer to that of the base plate than that of the adhesive.

In general, in another aspect, the invention features a method for securing a first optical module to an base plate supporting one or more additional modules. The method includes: i) positioning the first module relative to the base plate to optical couple the first module to the one or more additional modules, wherein one of the first module and the base plate has at least one hole passing through it; ii) introducing at least one stabilizing element into each hole to contact the other of the first module and the base plate; and iii) securing together the stabilizing element, the first module, and the base plate when the first module is aligned with the one or more additional modules.

Embodiments of the method may include any of the following features.

The first module may have the hole passing through it.

The at least one hole may be multiple holes (e.g., three or more holes).

Each stabilizing element may at least partially fill space in the hole when it contacts the other of the first module and the base plate. For example, the stabilizing element may be a ball, and the ball may be slightly undersized relative to the hole.

The other of the first module and the base plate may include a planar surface, and the stabilizing element may contact the planar surface.

The other of the first module and the base plate may include a protrusion that extends into each hole. In such cases, the stabilizing element(s) at least partially fill space in each hole between the protrusion and the one of the first module and the base plate having the hole. For example, the protrusion may have a thickness that narrows as it extends into the hole. Furthermore, multiple stabilizing elements (e.g., balls) may be introduced into each hole to surround each protrusion.

The positioning of the first module relative to the base plate may include positioning the first module relative to the base plate based on transmission efficiency of an optical signal between the first module and the one or more additional modules. Furthermore, the positioning of the first module relative to the base plate may also include passively aligning the first module relative to the base plate prior to the positioning of the first module relative to the base plate based on the transmission efficiency of the optical signal. In any case, the positioning of the first module relative to the base plate may include using a vacuum chuck.

The stabilizing elements may be introduced after the first module is aligned with the one or more additional modules.

The securing may include adhesively securing together the stabilizing element, the first module, and the base plate when the first module is aligned with the one or more additional modules. For example, the adhesively securing may include introducing an adhesive into each hole. The adhesively securing may further include exposing the adhesive to ultraviolet radiation, exposing it to an anaerobic environment, and/or adjusting temperature to cure the adhesive. Typically, the stabilizing elements have a coefficient of thermal expansion substantially closer to that of the base plate than that of the adhesive.

The securing may include securing together the stabilizing element, the first module, and the base plate with solder when the first module is aligned with the one or more additional modules. For example, the securing may include introducing the solder into each hole.

In general, in another aspect, the invention features an optical assembly including: i) a base plate supporting a first optical module and one or more additional optical modules, wherein the first module is aligned to optical couple to the one or more additional modules, the first module being secured to the base plate; and ii) at least three stabilizing elements positioned between the first module and the base plate to contact both of the aligned first module and the base plate, wherein one of the first module and the base plate includes at least one elongate track positioned for translating the stabilizing elements between the first module and the base plate.

Embodiments of the optical assembly may include any of the following features.

The at least one elongate track may include multiple elongate tracks.

The stabilizing elements may be balls. The balls may have different dimensions.

Each stabilizing element may be positioned to contact one of the first module and the base plate at only one point.

The stabilizing elements may be positioned to contact the first module at a first set of points and the base plate at a second set of points, where the first set of points defines a first plane that is angled relative to a second plane defined by the second set of points.

The first module may be secured to the base plate by glue or solder.

In general, in another aspect, the invention features an optical assembly including: i) a base plate supporting a first optical module and one or more additional optical modules, wherein the first module is optically coupled to the one or more additional modules, and wherein one of the first module and the base plate has at least one hole passing through it; and ii) at least one stabilizing element positioned in each hole to contact the other of the first module and the base plate, wherein the at least one stabilizing element, the first module, and the base plate are secured to one another.

Embodiments of the optical assembly may include any of the following features.

The first module may have the hole passing through it.

The at least one hole may include multiple holes (e.g., three or more holes).

Each stabilizing element may at least partially fill space in the hole when it contacts the other of the first module and the base plate. For example, the stabilizing element may be a ball, and the ball may be slightly undersized relative to the hole.

The other of the first module and the base plate may includes a planar surface, and the stabilizing element may contact the planar surface.

The other of the first module and the base plate may include a protrusion that extends into each hole. The stabilizing element(s) may at least partially fill space in each hole between the protrusion and the one of the first module and the base plate having the hole. For example, the protrusion may have a thickness that narrows as it extends into the hole. Furthermore, multiple stabilizing elements (e.g., balls) may be introduced into each hole.

The at least one stabilizing element, the first module, and the base plate may be secured to one another by glue or solder.

In any of the optical assemblies and optical assembly methods described above, the first module may include any of a fiber, a fiber array, a light source, an arrays of light sources, a detector, a detector array, an integrated waveguide, and a planar light wave circuit (PLC). Likewise, the second module may include any of a fiber, a fiber array, a light source, an arrays of light sources, a detector, a detector array, an integrated waveguide, and a planar light wave circuit (PLC).

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety. In case of conflict, the present specification, including definitions, will control.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective drawing of an optical assembly 10.

FIG. 2 is a schematic drawing of a first module 40 in optical assembly 10.

FIG. 3 is an exploded view of optical assembly 10.

FIG. 4 is a side view of a passively aligned second module 60 in optical assembly 10.

FIG. 5 is a side view of actively aligned first module 40.

FIG. 6 is a perspective view of actively aligned first module 40.

FIG. 7 is an upside-down view of optical assembly 10 with base plate 20 removed.

FIG. 8 is a coordinate reference frame for the active alignment of first module 40.

FIG. 9 is a top view of an optical assembly 110.

FIG. 10 is a cross-sectional drawing of optical assembly 110 along a first module 140.

FIG. 11 is a perspective view of optical assembly 110 along first module 140.

FIG. 12 is a cross-sectional drawing of an additional embodiment of the optical assembly.

Like reference symbols in the various drawings indicate like elements.

### DETAILED DESCRIPTION

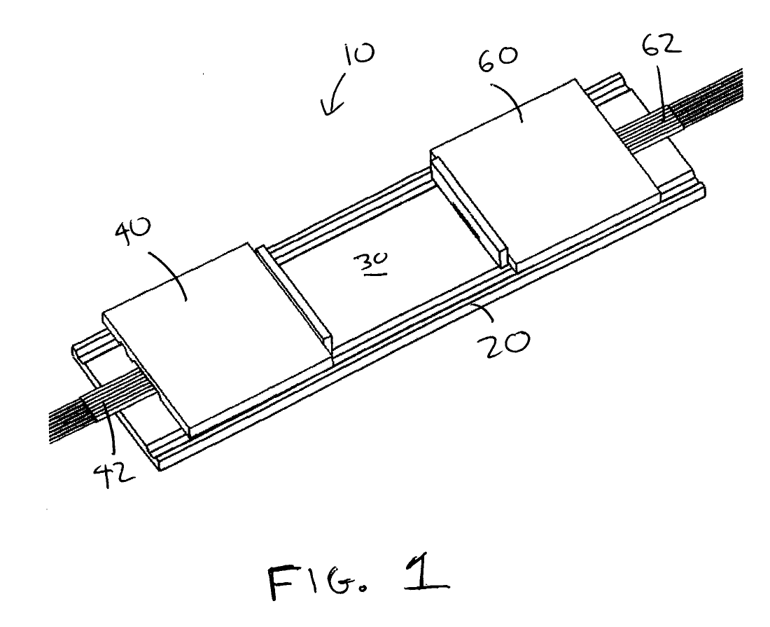

FIG. 1 shows an optical assembly 10 including a first module 40 and and a second module 60 each secured to a base plate 20. First module 40 carries fiber array 42 and second module 60 carries fiber array 62. First module 40 and second module 60 are spaced from one another by a central region 30 of base plate 20. During operation, light emerging from each fiber in one of the fiber arrays (for example, fiber array 42) propagates across central region 30 and couples into a corresponding fiber in the other fiber array (for example, fiber array 62). Depending on the application, central region 30 may support an additional module (not shown) configured to interact with the light as it propagates between the two fiber arrays.

For example, the additional module may include an optical switching device (e.g., a mirror array) that selectably redirects light emerging from each fiber of the first array to a corresponding selected fiber of the second array. In another example, the additional module may include one or more polarizing beam splitters that translate a selected polarization by an amount related to the pitch of the fiber arrays, while leaving the position of the orthogonal polarization unchanged. In such cases, the additional module may further include additional components, such as polarization rotator arrays (e.g., an electro-optic crystal such as yittrium vanadate, or a liquid-crystal retarder array) positioned between adjacent polarizing beam splitters. Such arrangements can be configured to selectively control which output fiber receives light for a given input fiber. More generally, the additional module may include any of a wide range of optical components suitable for manipulating, processing, redirecting, and/or monitoring optical signals coupled between the first module and the second module.

First module 40 has an optical axis corresponding to the propagation direction of light emerging from fiber array 42 (or equivalently the propagation direction for light that is to be optimally coupled into fiber array 42). Second module 60 has an optical axis corresponding to the propagation direction for light that is to be optimally coupled into fiber array 62 (or equivalently the propagation direction of light emerging from fiber array 62). The first and second modules are secured to base plate 20 to align their optical axes, taking into account any modification to the light propagation caused by any additional modules secured to the central region of the base plate. Because of the alignment, the optical coupling efficiency between the first and second modules is optimized.

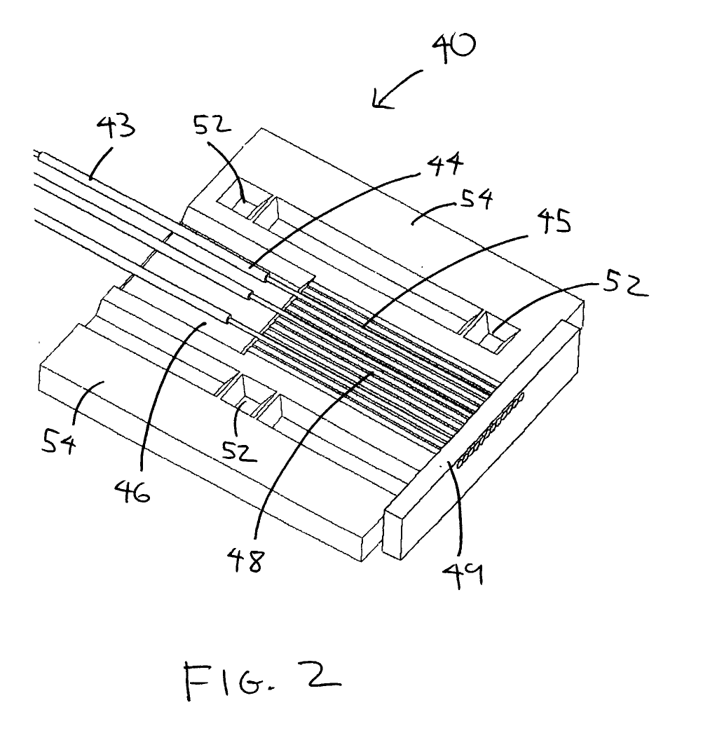

The underside of first module 40 (that which is adjacent the base plate) is shown in FIG. 2. Fiber array 42 includes individual fibers 43 that each include a protective fiber cladding portion 44 and a bare optical fiber portion 45 (i.e., the protective cladding is absent). The protective fiber cladding portions are supported over a planar portion 46 of module 40 and the bare fiber portions are supported by an array of v-grooves 48 etched into module 40, where planar portion 46 is recessed relative to the array of v-grooves 48 to account for the thickness of the protective cladding. The v-grooves 48 are positioned to receive and align the bare fiber portions. A compliant adhesive may be used between the protective fiber cladding portions and planar portion 46. The adhesive is sufficiently compliant to not constrain the positioning of the bare fibers by the v-grooves. Thus, plane 46 provides an anchor point for a compliant strain relief formed by the adhesive. First module 40 further includes a lens array 49 including an individual lens element (e.g., a spherical lens) positioned to collimate the light emerging from each fiber (or focus light being directed into each fiber). A suitable method for aligning the lens array with the array of fibers are disclosed in commonly owned U.S. patent application Ser. No. 10/098,742 entitled “Alignment Of A Lens Array And A Fiber Array” and filed Mar. 15, 2002, the contents of which are incorporated herein by reference. The first module may further include fiber cap (not shown) positioned over the bare fiber portions to secure them in the v-grooves.

First module 40 further includes three etched pockets 52 each sized to receive a support ball (not shown) for use in passive alignment with the base plate, which is discussed in greater detail below. The etched pockets are located with photolithographic tolerances to optimize the passive alignment. First module 40 also includes side planar portions 54, which define the contact region for the stabilizing elements used following active alignment, which is discussed in greater detail below.

The structure for second module 60, which in the presently described embodiment also includes a fiber array, is identical to that described for the first module with reference to FIG. 2. In the subsequent description, features of second module corresponding to those described in FIG. 2 will have a reference numeral increased by 20 relative to that in FIG. 2.

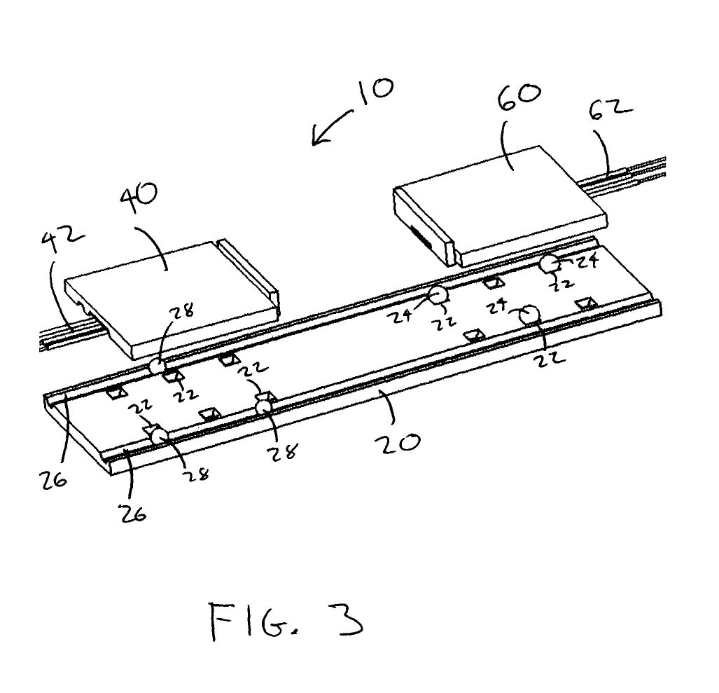

FIG. 3 shows an exploded view of optical assembly 10 with modules 40 and 60 spaced from base plate 20. Base plate 20 includes etched pockets 22 located with photolithographic accuracy. Etched pockets 22 are sized to receive balls 24, which mate with corresponding etched pockets on the underside of module 60 to passively align the second module with the base plate. Base plate 20 further includes a pair of v-groove shaped tracks 26 extending along its length. The two tracks are oriented substantially parallel to one another and are configured to receive balls 28, which are used to stabilize the position of the first module relative to the base plate following active alignment.

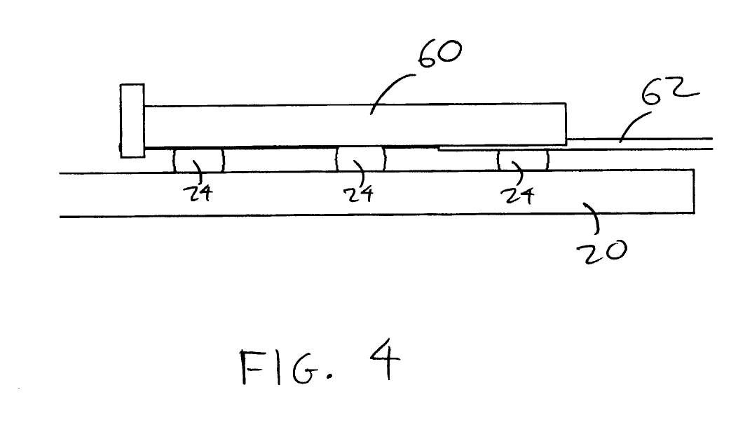

FIG. 4 shows a side view of the passively aligned second module and base plate. Each ball 24 rests in a corresponding one of the etched pockets 22 of base plate 20 and mates with a corresponding etched pocket 72 of second module 60 (like etched pocket 52 in the first module as shown in FIG. 2). Each of the etched pockets narrows with depth (e.g., it may have a conical or pyramidal structure) and each ball 24 is sized to contact the sides of the etched pocket. As a result, three of the balls 24 can be used to accurately locate second module 60 relative to base plate 20.

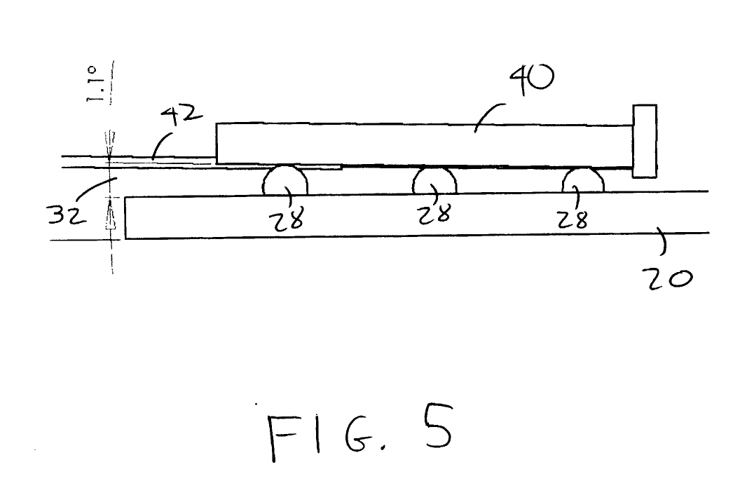

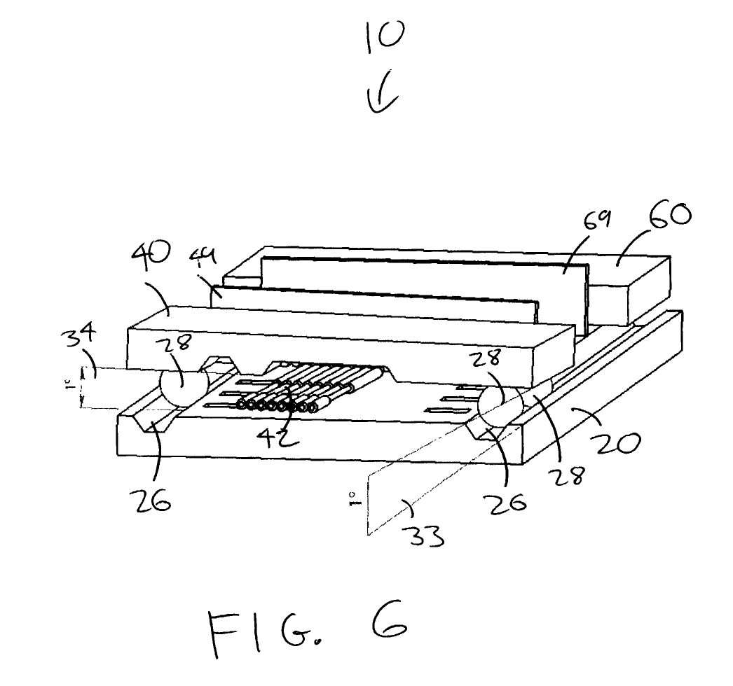

FIG. 5 shows a side view of the actively aligned first module and base plate and FIG. 6 shows a perspective view of the actively aligned first module and base (with the second module in the background). As shown, the bottom face of aligned first module 40 forms a small angle 32 with the plane of base plate 20. This small angle (e.g., 1.1°) is nominally preset when the first module is fabricated by adjusting the transverse position of lens array 49 relative to bare fiber portions 45. This transverse adjustment introduces an angle to the optical axis defined by the first module (relative to the second module), and causes the aligned first module to be tilted relative to the base plate. By using the systems and methods described in the previously cited patent application entitled “Alignment Of A Lens Array And A Fiber Array,” a selected tilt angle may be preset with high accuracy.

The tilt angle between the first module and the base plate allow three balls 28 to be translated along tracks 26 until they contact side planar portions 54 of first module 40 and thereby “lock-in” the relative positions of the planes defined by the underside of first module 40 and base plate 20. The sizes of the balls 28, which typically differ from one another, are selected to produce a rigid mechanical coupling between the first module and the base plate for side-to-side and front-to-back angularity. Although the figures show the use of three balls, which is sufficient to uniquely fix and mechanically couple the planes defined by the first module and the base plate, more balls may be used to provide additional support. As shown in the perspective view of FIG. 6, the angle between the first module and the base plate may include components both parallel (“pitch” tilt 33) and perpendicular (“roll” tilt 34) to tracks 26.

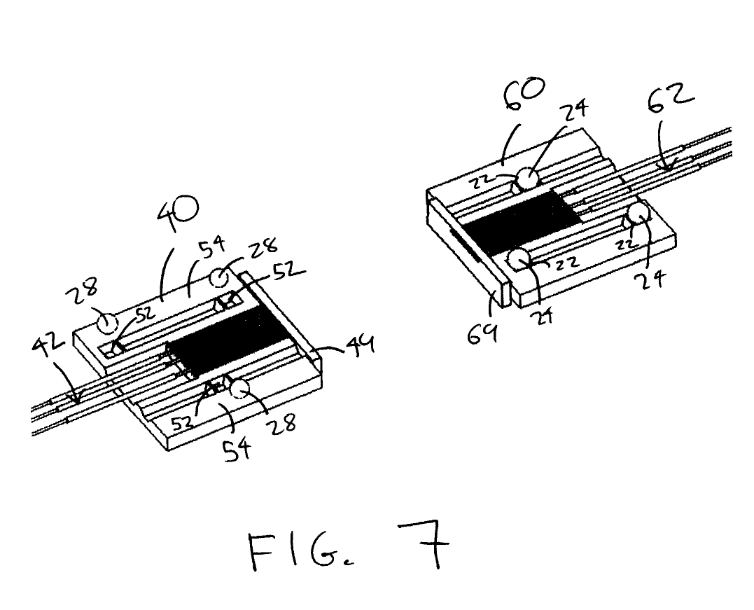

Referring now to FIG. 7, the undersides of modules 40 and 60 of completed optical assembly 10 is shown with base plate 20 removed. Different sized balls 28 contact planar side portions 54 of first module 40, whereas balls 24 (which are typically all the same size) are fixed within etched pockets 72 of second module 60.

In the completed optical assembly 10, first and second modules 40 and 60 are permanently attached to base plate 20 by glue, solder, and/or mechanical fixturing (e.g., a spring clamp). For example, a suitable glue may be a heat- and/or UV-curable epoxy. To reduce the difference in thermal expansion between the epoxy and the base plate and modules, the epoxy may be highly filled with silica particles. Where glue or solder is used, it may be preferable that the glue or solder attach each module to their corresponding balls, and the base plate to the balls, thereby minimizing the thickness of the hardened glue or solder and reducing thermally induced strain caused by any mismatch in thermal expansion. Thus, the modules are permanently attached to the base plate through the balls. Nonetheless, in additional embodiments, it is also possible for glue or solder to attach the modules directly to the base plate. However the modules are secured to the base plate, balls 24 and 28 function as stabilizing elements to reduce any forces associated with the attachment (e.g., glue or solder shrinkage forces) that might otherwise perturb the alignment of the modules.

Suitable angles for the nominal angular offset between the first module and the base plate include angles in the range of about 20 to 24 mrad for pitch and angles in the range of 1 mrad to 5 mrad for roll. Angles outside these ranges are also possible. Also, for example, a suitable diameter for balls 24 may be about 1.2 mm, and suitable diameters for balls 28 may be about 1.1 mm, 1.05 mm, and 1.00 mm. Of course, in other embodiments and depending on the application, the balls may have different diameters. Suitable materials for balls 24 and 28 include stainless steel. Furthermore, in some embodiments it is preferable that the balls be magnetic (as described further below). For example, the balls can be made of 304SS stainless steel, which is a soft magnet. The modules and base plate may be made from silicon to exploit established photolithographic and crystallographic etching techniques from the semiconductor industry for accurately locating the etched pockets and tracks.

The base plate and modules in optical assembly 10 include features for both passive and active alignment, even though the first module is secured to the base plate using the active alignment features and the second module is secured to the base plate using the passive alignment features. Although this is not necessary, the presence of both sets of features provides additional flexibility and utility. For example, as described below, the passive alignment features of the first module may be used to provide an initial starting position for the active alignment. In other embodiments, however, the first module may only include features for active alignment and the second module may only include features for passive alignment, or vice versa.

We now describe a method by which modules 40 and 60 are secured to base plate 20 to form the completed optical assembly 10.

First, module 60 is passively aligned and attached to base plate 20. The passive alignment includes positioning balls 24 in etched pockets 22 of the base plate, and then positioning module 60 over the base plate so that balls 24 in the base plate mate with etched pockets 72 of module 60. The subsequent attachment of module 60 to base plate 20 can involve glue (e.g., an adhesive epoxy), solder, and/or mechanical fixturing as described above. Any additional modules are then passively aligned and attached to the central region of the base plate.

Then first module 40 is passively aligned on base plate 10 opposite the attached second module using etched pockets 52 on the first module and additional balls like balls 24 used to passively align the second module and those etched pockets 22 on the base plate opposite the passive aligned second module.

An automated pick-up tool such as a mechanically articulated vacuum chuck is then used to lock onto the passively aligned first module. The automated pick-up tool then stores the location of the vacuum chuck used to lock onto the passively aligned first module using, for example, optical encoders. This stored location may correspond to all six degrees of freedom, i.e., the three translational and three rotational degrees of freedom of the first module relative to the base plate. The stored location defines an initial position for a subsequent active alignment.

The pick-up tool then lifts the passively aligned first module away from the base plate and the balls used for the passive alignment of the first module are removed from the corresponding etched pockets of the base plate. The pick-up tool then repositions the first module at the stored position corresponding to the passive alignment.

A light signal is then transmitted between one or more corresponding pairs of fibers in the first and second fiber arrays and the transmission efficiency is measured. The measured transmission efficiency is used as a control signal to the pick-up tool to adjust the position of the first module along each of multiple degrees of freedom to maximize the measured transmission efficiency and more precisely align the optical axis of the first module to that of the second module and any intervening modules. Suitable optimization routines for such active alignment are known in the art. We now describe one example of a suitable alignment routine.

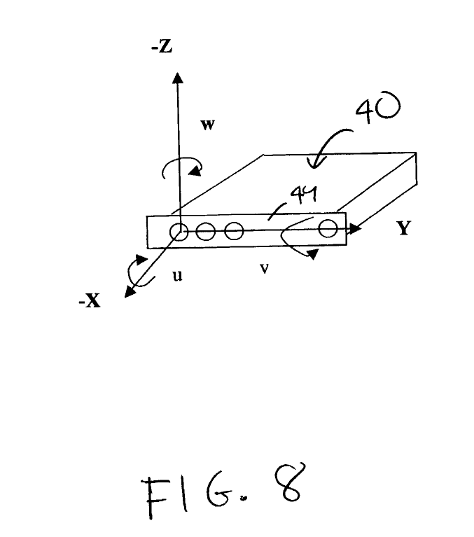

First a pivot point is defined for the first module. The pivot point sets the origin for a coordinate system shown in FIG. 8 (translational coordinates X, Y, Z, and rotational coordinates U, V, W). Source light is then directed from an end fiber of the second module to the corresponding end fiber of the first module. The pick-up tool then positions the first module to optimize the optical coupling. First, it uses a hill climb algorithm for Z with V, followed by Y with W to optimize the signal. Then, it moves along X to optimize this first optical coupling signal. Then, the pick-up tool repeats the hill climb algorithm for Z with V, followed by Y with W. Thereafter, source light is directed from the opposite end fiber of the second module to the corresponding opposite end fiber of the first module to define a second optical coupling signal. With respect to this second signal, the pick-up tool positions the first module with respect to U axis until maximum coupling is achieved. Based again on the first optical coupling signal, the pick-up tool repositions the first module using hill climb algorithm Z with V, followed by Y with W to maximize the couple. If necessary, adjustment along U is repeated followed by a subsequent repetition of the hill climb algorithm for Z with V, followed by Y with W. The active alignment is then complete. The “hill climb” algorithm mentioned above is simply an iterative process of stepping along the respective coordinate(s) to maximize signal.

Because no balls (such as those used for the passive alignment) are present during the active alignment, the first module is free to move over a large volume relative to the base plate. We refer to this large volume as a large “gap.” Because of the large gap, the active alignment routine can sample a range of positions that necessarily encompasses the optimal position of the first module despite any imperfectations in the passive alignment of the second module and any intervening modules. In particular, the gap can be large enough that the alignment routine can sample through the position along each degree of freedom corresponding to the peak transmission efficiency for that degree of freedom, thereby making identification of the optimal position along each coordinate more accurate and reliable.

Moreover, the active alignment can determine a final position for the first module that offsets any optical alignment error accumulated from the passive alignment and tolerances of the second module and any other modules in the opto-mechanical sequence.

After the active alignment routine drives the pick-up tool to position the first module relative to the optical bench at an optimal position of optically coupling the first module to the second module and any intervening modules, at least three balls 28 are translated along tracks 26 on the base plate until they contact planar side regions 54 of the first module. The balls “take-up” the large gap exploited by the active alignment routine.

As described above with reference to FIGS. 5 and 6 the optimal position of the first module is nominally preset to define an angle between planes defined by the base plate and the underside of the first module. As a result, balls 28 introduced onto tracks 26 on the base plate initially clear contact with the first module. As each ball is translated along one of the tracks, however, it eventually contacts one of the planar side regions on the underside of the first module. Notably, each ball 28 only contacts the underside of the first module at a single point, thereby minimizing any perturbation of the optimal alignment. At least three balls are used to uniquely fix the relative positions of the planes defined by the base plate and the first module. Additional balls may be positioned along the tracks to contact the underside of the first module and provide additional mechanical coupling between the base plate and the first module. Because of the angle between the planes defined by first module and the base plate, balls 28 typically have different dimensions. For example, in embodiments such as that shown in the FIGS. 4-7 in which the base plate has two tracks of equal depth, at least two of the three balls used to fix the mechanical coupling between the aligned first module and the base plate have different diameters.

Nominal knowledge of the optimal position of the first module can guide selection of the appropriate diameters for balls 28 such that each of the balls contacts the underside of the first module at some position along one the tracks on the base plate. Furthermore, a camera and frame grabber may used to record an image of the optimally aligned first module (following the active alignment) and determine the gap spacing between the first module and the base plate, which information may be used to further guide the selection of the diameters of balls 28.

In additional embodiments, the base plate may have more than two tracks, some of which have different depths from one another. In such cases, the balls that take-up the gap following active alignment may all have the same diameter. For example, there may be a middle track having a different depth from the two side tracks, or there may be pairs of tracks at each side, each having different depths. Tracks of different depth may be fabricated by masking off tracks of different widths during their microlithographic fabrication process.

As described above, in some embodiments, balls 28 are magnetic, and to translate the balls along the tracks in the base plate, a magnet beneath the base plate is drawn parallel to the track to magnetically pull the balls along the tracks. For example, a suitable magnet is an individual or array of Neodymium-Iron-Boron magnets. Furthermore, the optical assembly may be tilted to gravitationally translate balls 28 along the track (i.e., the balls may roll along the track due to gravity). In yet further embodiments, a chute system may be used to eject the balls onto the tracks with some initial velocity. Any single one or combination of these methods may be used to translate the balls along the tracks of the base plate.

After balls 28 are in position, first module 40 is permanently attached to base plate 20 using glue (e.g., an adhesive epoxy), solder, and/or mechanical fixturing as described above. Again, as described above, balls 28 provide mechanical coupling between the first module and the base plate to reduce the impact of subsequent forces associated with the permanent attachment (e.g., adhesive and/or solder shrinkage). The glue or solder may be injected between the first module and the base plate after balls 28 are in position. Thereafter, a spring clamp may be used to secure the module to the base plate so that the assembly can be separated from the vacuum chuck and, for example, transported into an oven to cure the epoxy. A foam pad may be used with the spring clamp to prevent any local stresses. Alternatively, in other embodiments, the pick-up tool can secure the first module in position during the permanent attachment process. For example, a UV-curable epoxy may be used and the assembly can be exposed to UV radiation even as the pick-up tool secures the first module in place. Furthermore, in other embodiments, an adhesive may be applied to the first module and the base plate before the active alignment, provided that its viscosity is sufficiently small to not interfere with the active alignment or the subsequent translation of the balls.

In another set of embodiments, the first module may have a different structure that likewise permits active alignment and subsequently incorporates a stabilizing element to provide at least some limited mechanical coupling between the optimally positioned first module and the base plate and to minimize the volume of glue or solder used to permanently attach the components.

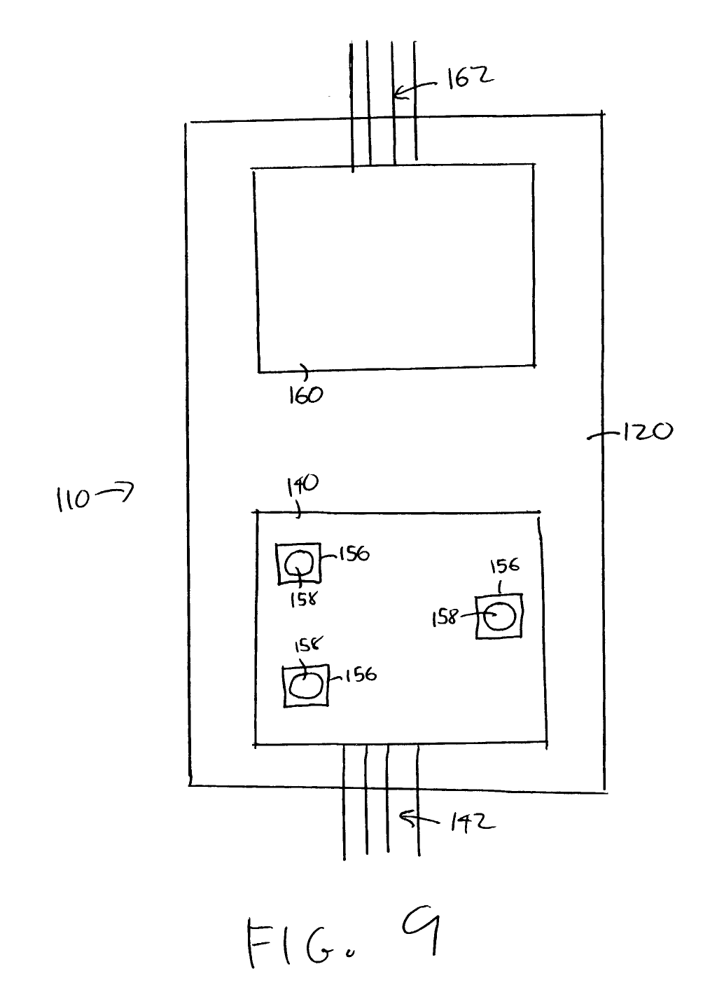

Referring to FIG. 9, an optical assembly 110 include a first module 140 and a second module 160 secured to a base plate 120. The first and second modules carry fiber arrays 142 and 162, respectively. As in optical assembly 10, one or more additional modules (not shown) may be positioned between modules 140 and 160. As in optical assembly 10 described above, the modules are positioned for optimal optical coupling efficiency. Base plate 120 is identical to base plate 20 except that it does not include any elongate tracks. Similarly, second module 160 is identical to second module 60 and is passive aligned and secured to base plate 20 in an identical manner as that described above for optical assembly 10.

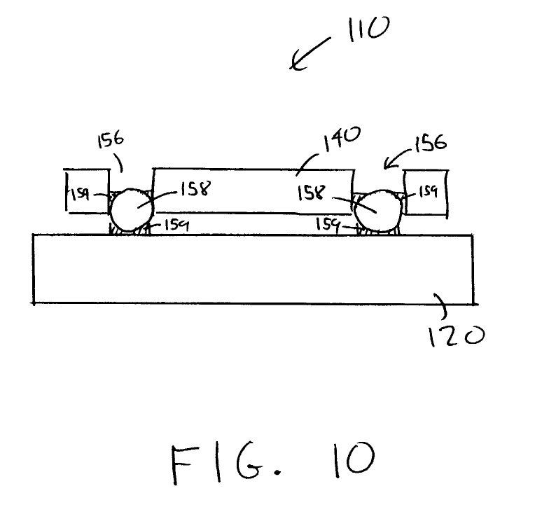

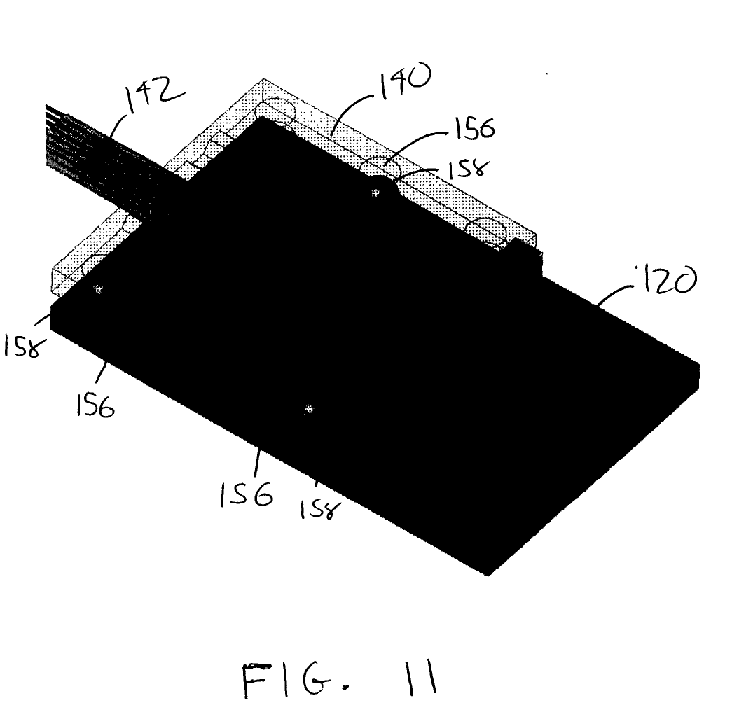

First module 140 is identical to first module 40 except that it includes three holes 156 passing through its thickness. A ball 158 is positioned in each hole 156. Each ball 158 is slightly undersized relative to its corresponding hole 156. Glue or solder in each hole attaches both first module 140 and base plate 120 to corresponding ball 158, thereby permanently securing first module 140 to base plate 120. FIG. 10 shows a cross-sectional view of base plate 120, first module 140, holes 156, balls 158, and glue or solder 159, and FIG. 11 shows a perspective view.

Balls 158 function as stabilizing elements that provide some limited mechanical coupling between base plate 120 and first module 140 and to minimize the volume of glue or solder used to permanently secure the first module to the base plate. Moreover, holes 156 and balls 158 permit active alignment.

Optical assembly 110 is assembled in a manner similar to that described above. First, second module 160 (and any additional modules) are passively aligned and secured to base plate 120. First module 120 is then nominally aligned by passive alignment and then actively aligned as described above. After first module 120 is optimally positioned, each ball 158 is introduced into a corresponding hole 156. While first module is held in position (e.g., by the pick-up tool), glue or solder is introduced into each hole and hardened to attach both first module 140 and base plate 120 to corresponding ball 158, thereby permanently securing first module 140 to base plate 120.

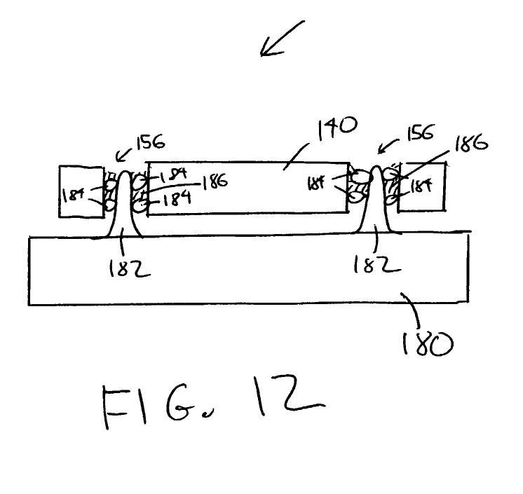

FIG. 12 shows a cross-sectional view similar to that of FIG. 10 for an additional embodiment of the optical assembly. In this embodiment, base plate 120 is replaced with base plate 180, which is identical to base plate 120 except that it includes protrusions 182 extending up through each hole 156 in first module 140. Typically the width of the protrusions narrow as they extend into the holes. For example, the protrusions may have a conical or pyramidal shape. Each protrusion 182 mates with a corresponding hole 156 to provide a nominal alignment of the first module on the base plate. However, the space between each protrusion and the edges of each corresponding hole in the first module is large enough to permit active alignment. Following the active alignment, one or more stabilizing elements 184 (e.g., smaller balls) are introduced into each hole to fill the space between each protrusion and the edges of the hole, and thereby provide some limited mechanical coupling between the aligned first module and the base plate. Glue or solder 186 fills additional space in each hole and attaches the protrusions to the stabilizing elements, and the stabilizing elements to the first module, thereby permanently securing the aligned first module to the base plate. Notably, the stabilizing elements minimize the volume of glue or solder to reduce any shrinkage forces caused by hardening of the glue or solder and/or any thermally induced strains caused a mismatch in thermal expansion coefficient.

In further embodiments of the optical assemblies described above, the first module and/or the second module may be different from a fiber array module. For example, one or both the modules may carry a light source (e.g., a laser diode) or an array of light sources (e.g., a laser diode array). Conversely, one or both of the modules may carry a photo-detector or an array of photo-detectors. Furthermore, one or both of the modules may be a planar light wave circuit (PLC) involving integrated waveguides. For example, the PLC may include an arrayed waveguide grating (AWG). The active alignment assembly method described above lends itself to PLC modules because the underside of the module may be entirely planar, such as is typical for a PLC. Finally, even where one or both of the modules carry an optical fiber, the module may carry a single optical fiber rather than an array of optical fibers. In all of these cases, the modules define optical axes that are to be aligned relative to one another to provide efficient optical coupling.

In yet further embodiments, one or more additional modules positioned between the first and second module may cause the optimal relative alignment of the first and second modules to be one in which the optical axes of the first and second module are not parallel. For example, an intervening module may cause the optical path of the light deviate at some angle. What is important is that there is efficient optical coupling between every adjacent pair of modules in the chain.

In yet further embodiments, the location of one or more of the alignment features can be interchanged between each module and the base plate. For example, in some additional embodiments, the elongate tracks may be on the first module rather than the base plate, and in other embodiments, there may be holes through the thickness of the base plate rather than the through the thickness of the first module, etc..

Furthermore, in additional embodiments, it may not be necessary to passively align the first module to determine an initial position for the active alignment. For example, the camera and frame grabber may be used to determine an initial position for the active alignment of the first module. In such cases, the features on the first module and the base plate used for the passive alignment need not be present.

In yet additional embodiments, one or more additional modules may be stacked over the first module and aligned with a corresponding set of one or more additional modules stacked over the second module. Such an arrangement may be used for optical coupling a two-dimensional fiber array to a corresponding set of optical components. The active and passive alignment features and methods described above may be used to successively position each layer of modules. For example, the optical assembly may include a base plate having successive tiers, each with a corresponding set of elongate tracks, for securing corresponding stacked modules. Balls in the elongate tracks on the first tier mechanically couple the lowest module to the base plate and balls in the elongate tracks on the second tier mechanical couple the second lowest module to the base plate, and so on.

Finally, in additional embodiments, the stabilizing elements used following the active alignment may be different from the balls described above. For example, the balls may not be strictly spherical. Furthermore, in some embodiments, the stabililizing elements may be hemispherical. For example, the stabilizing element may have an upper portion that is hemispherical for contacting the planar underside of the first module at a single point and a lower portion that has a different shape suitable for translation along the elongate tracks. Furthermore, in additional embodiments, the tracks may not be necessary for guiding the translation of the stabilizing elements.

A number of embodiments of the invention have been described. Nevertheless, it will be understood that various modifications may be made without departing from the spirit and scope of the invention. Accordingly, other embodiments are within the scope of the following claims.

What is claimed is:

1. A method for securing a first optical module to a base plate supporting one or more additional modules, the method comprising:
positioning the first module relative to the base plate to optically couple the first module with the one or more additional modules;
introducing at least three stabilizing elements between the aligned first module and the base plate;
positioning each stabilizing element to contact both of the aligned first module and the base plate; and
securing the first module to the base plate after the stabilizing elements are in position.

2. The method of claim 1, wherein the three stabilizing elements are balls.

3. The method of claim 2, wherein the balls have different dimensions.

4. The method of claim 1, wherein each stabilizing element is positioned to contact at least one of the aligned first module and the base plate at only one point.

5. The method of claim 1, wherein the first module has a planar surface and wherein the stabilizing elements are positioned to contact the planar surface.

6. The method of claim 1, wherein the stabilizing elements are positioned to contact the aligned first module at a first set of points and the base plate at a second set of points, wherein the first set of points defines a first plane that is angled relative to a second plane defined by the second set of points.

7. The method of claim 6, wherein the positioning of the stabilizing elements comprises translating each stabilizing element between the first and second planes until it contacts both of the aligned first module and the base plate.

8. The method of claim 7, wherein the translating comprises applying any of a magnetic force, a gravitational force, and a mechanical force to each stabilizing element.

9. The method of claim 7, wherein one of the first module and the base plate comprises at least one track to guide the translations of the stabilizing elements.

10. The method of claim 9, wherein the base plate comprises the track.

11. The method of claim 10, wherein the at least one track comprises multiple tracks.

12. The method of claim 1, wherein the positioning of the first module relative to the base plate comprises positioning the first module relative to the base plate based on transmission efficiency of an optical signal between the first module and the one or more additional modules.

13. The method of claim 12, wherein the positioning of the first module relative to the base plate further comprises passively aligning the first module relative to the base plate prior to the positioning the first module relative to the base plate based on the transmission efficiency of the optical signal.

14. The method of claim 1, wherein the positioning of the first module relative to the base plate comprises using a vacuum chuck.

15. The method of claim 1, wherein the first module is adhesively secured to the base plate after the stabilizing elements are in position.

16. The method of claim 1, wherein the first module is secured to the base plate with solder after the stabilizing elements are in position.

17. The method of claim 1, wherein the first module is secured to the base plate with a mechanical clamp after the stabilizing elements are in position.

18. The method of claim 17, wherein the first module is further secured to the base plate with glue or solder following the mechanical clamping.

19. The method of claim 18, further comprising removing the mechanical clamp after the glue or solder has hardened.

20. The method of claim 15, wherein the adhesive is applied to at least one of the first module and the base plate before the stabilizing elements are introduced and the adhesive is hardened after the stabilizing elements are in position to adhesively secure the first module to the base plate.

21. The method of claim 15, wherein the adhesive is applied to at least one of the first module and the base plate after the stabilizing elements are introduced and then hardened to adhesively secure the first module to the base plate.

22. An optical assembly comprising:
a base plate supporting a first optical module and one or more additional optical modules, wherein the first module is aligned to optical couple to the one or more additional modules, the first module being secured to the base plate; and
at least three stabilizing elements positioned between the first module and the base plate to contact both of the aligned first module and the base plate,
wherein one of the first module and the base plate comprises at least one elongate track positioned for translating the stabilizing elements between the first module and the base plate.

23. The optical assembly of claim 22, wherein the stabilizing elements are balls.

24. The optical assembly of claim 23, wherein the balls have different dimensions.

25. The optical assembly of claim 22, wherein each stabilizing element is positioned to contact one of the first module and the base plate at only one point.

26. The optical assembly of claim 22, wherein the at least one elongate track comprise multiple elongate tracks.

27. The optical assembly of claim 22, wherein the stabilizing elements are positioned to contact the first module at a first set of points and the base plate at a second set of points, wherein the first set of points defines a first plane that is angled relative to a second plane defined by the second set of points.

28. The optical assembly of claim 22, wherein the first module is secured to the base plate by glue or solder.

29. A method for securing a first optical module to an base plate supporting one or more additional modules, the method comprising:
positioning the first module relative to the base plate to optical couple the first module to the one or more additional modules, wherein one of the first module and the base plate has at least one hole passing through it;
introducing at least one stabilizing element into each hole to contact the other of the first module and the base plate; and
securing together the stabilizing element, the first module, and the base plate when the first module is aligned with the one or more additional modules.

30. The method of claim 29, wherein the securing comprises adhesively securing together the stabilizing element, the first module, and the base plate when the first module is aligned with the one or more additional modules.

31. The method of claim 29, wherein the securing comprises securing together the stabilizing element, the first module, and the base plate with solder when the first module is aligned with the one or more additional modules.

32. The method of claim 29, wherein the first module has the hole passing through it.

33. The method of claim 29, wherein the at least one hole comprises multiple holes.

34. The method of claim 29, wherein the stabilizing element is a ball.

35. The method of claim 29, wherein each stabilizing element at least partially fills space in the hole when it contacts the other of the first module and the base plate.

36. The method of claim 29, wherein the other of the first module and the base plate comprises a planar surface, and the stabilizing element contacts the planar surface.

37. The method of claim 29, wherein the other of the first module and the base plate comprises a protrusion that extends into each hole.

38. The method of claim 37, wherein the stabilizing elements at least partially fill space in each hole between the protrusion and the one of the first module and the base plate having the hole.

39. The method of claim 38, wherein multiple stabilizing elements are introduced into each hole.

40. The method of claim 39, wherein the stabilizing elements are balls.

41. The method of claim 29, wherein the stabilizing elements are introduced after the first module is aligned with the one or more additional modules.

42. The method of claim 29, wherein the positioning of the first module relative to the base plate comprises positioning the first module relative to the base plate based on transmission efficiency of an optical signal between the first module and the one or more additional modules.

43. The method of claim 42, wherein the positioning of the first module relative to the base plate further comprises passively aligning the first module relative to the base plate prior to the positioning the first module relative to the base plate based on the transmission efficiency of the optical signal.

44. The method of claim 29, wherein the positioning of the first module relative to the base plate comprises using a vacuum chuck.

45. The method of claim 30, wherein the adhesively securing comprises introducing an adhesive into each hole.

46. The method of claim 31, wherein the securing further comprises introducing the solder into each hole.

47. An optical assembly comprising:
a base plate supporting a first optical module and one or more additional optical modules, wherein the first module is optically coupled to the one or more additional modules, and wherein one of the first module and the base plate has at least one hole passing through it; and
at least one stabilizing element positioned in each hole to contact the other of the first module and the base plate,
wherein the at least one stabilizing element, the first module, and the base plate are secured to one another.

48. The optical assembly of claim 47, wherein the first module has the hole passing through it.

49. The optical assembly of claim 47, wherein the at least one hole comprises multiple holes.

50. The optical assembly of claim 47, wherein the stabilizing element is a ball.

51. The optical assembly of claim 47, wherein each stabilizing element at least partially fills space in the hole when it contacts the other of the first module and the base plate.

52. The optical assembly of claim 47, wherein the other of the first module and the base plate comprises a planar surface, and wherein the stabilizing element contacts the planar surface.

53. The optical assembly of claim 47, wherein the other of the first module and the base plate comprises a protrusion that extend into each hole.

54. The optical assembly of claim 53, wherein the stabilizing elements at least partially fill space in each hole between the protrusion and the one of the first module and the base plate having the hole.

55. The optical assembly of claim 54, wherein multiple stabilizing elements are introduced into each hole.

56. The optical assembly of claim 55, wherein the stabilizing elements are balls.
